(19) United States
(12) Patent Application Publication
(10) Pub. No.: US 2025/0043604 A1
(43) Pub. Date: Feb. 6, 2025

(54) DOOR HOLDING DEVICE

(71) Applicant: Joseph Donald Vaz, Burlington (CA)

(72) Inventor: Joseph Donald Vaz, Burlington (CA)

(21) Appl. No.: 18/363,343

(22) Filed: Aug. 1, 2023

(51) Int. Cl. E05C 17/02

(52) U.S. Cl. CPC E05C 17/02

(57) ABSTRACT

A door holding device that is movable between a first position and a second position so as to operably couple with a door and maintain the door in an open position. The invention includes a base support member that is secured to a wall proximate a door. A hinge mount is secured to the base support member and is operably coupled to an arm member. The arm member is hingedly secured within the hinge mount and extends outward therefrom being maintained in a generally horizontal position. The arm member has secured to the second end thereof a door engagement member. The invention is formed so as to operably engage an upper edge of a door and transition the door so as to be adjacent a rearward portion thereof. The door engagement member is operable to releasably secure over the upper edge of the door to retain in an open position.

### FIELD OF THE INVENTION

The present invention relates generally to mechanical assist devices, more specifically but not by way of limitation, a door holding device wherein the present invention is mounted on a wall proximate a door and wherein the present invention is configured to releasably couple to the door so as to maintain the door in an open position.

### BACKGROUND

Whether on commercial structures or residential homes, all are equipped with a plurality of doors that facilitate traversal in and out of the building. While interior doors typically do not have spring hinges or hydraulics, it is very common for exterior doors to be equipped with some type of mechanism that will facilitate the automatic closing of the door. These devices are installed for safety as well as to ensure minimal impact of the air temperature being maintained within the structure.

There are many instances when going in and out of a building when it may be desired to maintain the door in an open position. By way of example but not limitation, during moving of furniture or carrying groceries into a building it is often desired to maintain the door in an open position. Also, many people have mobility issues and holding a door while attempting to traverse therethrough can be challenging.

Accordingly, there is a need for a device that can be mounted proximate a door wherein the present invention is configured to releasably secure to a top edge of the door and maintain the door in an open position.

### SUMMARY OF THE INVENTION

It is the object of the present invention to provide a door holding device that is configured to maintain a door in an open position wherein the present invention includes a base support member.

Another object of the present invention is to provide a device configured to engage a top edge of a door to maintain the door in an open position wherein the base support member includes a hinge mount.

A further object of the present invention is to provide a door holding device that is configured to maintain a door in an open position wherein the hinge mount comprises a first vertical support member and a second vertical support member having a pin extending thereacross.

Yet a further object of the present invention is to provide a device configured to engage a tope edge of a door to maintain the door in an open position wherein the present invention includes an arm member wherein the arm member has a first end and a second end.

Still another object of the present invention is to provide a door holding device that is configured to maintain a door in an open position wherein the first end of the arm member is operably coupled to the hinge mount.

An additional object of the present invention is to provide a device configured to engage a tope edge of a door to maintain the door in an open position wherein the arm member has a door engagement member secured to the second end thereof.

Yet a further object of the present invention is to provide a door holding device that is configured to maintain a door in an open position wherein the present invention further includes an outer support arm wherein the outer support arm is operably coupled to a release member.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention installed on a wall; and

FIG. 2 is a detailed view of the present invention; and

FIG. 3 is a detailed front view of the base support member of the present invention; and

FIG. 4 is an end view of the base support member of the present invention.

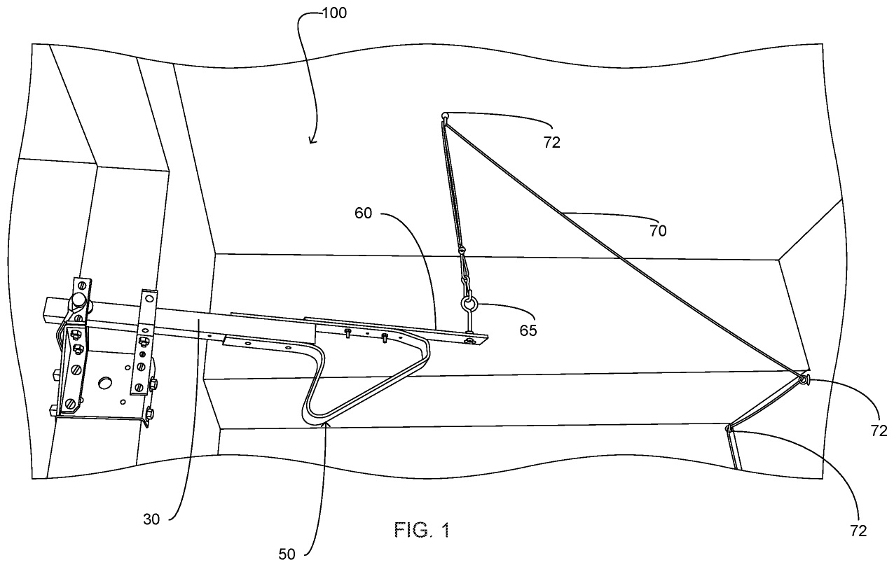

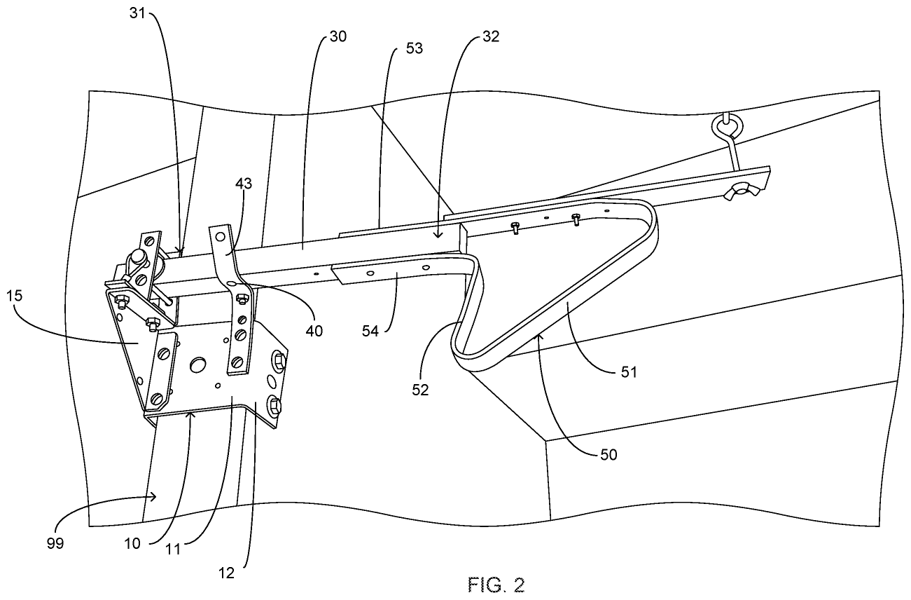

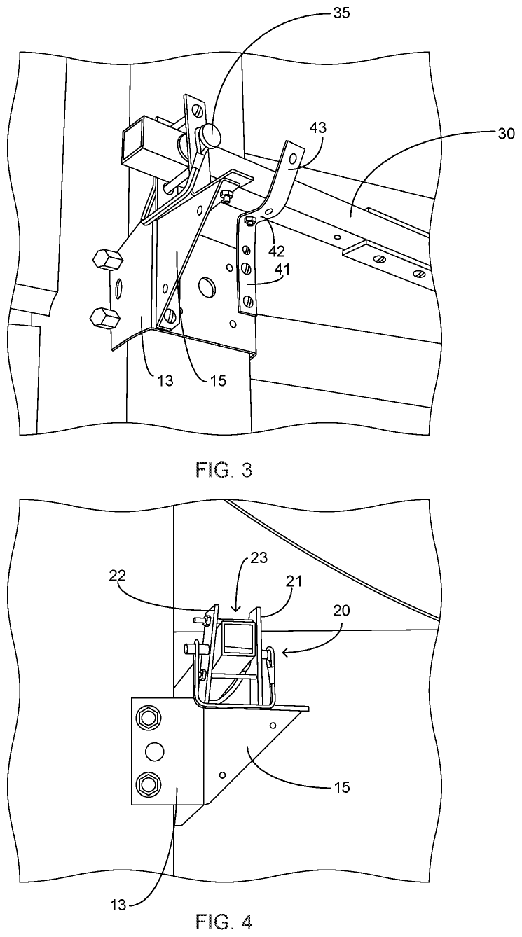

### DETAILED DESCRIPTION

Referring now to the drawings submitted herewith, wherein various elements depicted therein are not necessarily drawn to scale and wherein through the views and figures like elements are referenced with identical reference numerals, there is illustrated a door holding device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the door holding device 100 is configured to be mounted proximate a door so as to engage therewith when the door is in an open position so as to releasably secure the door in the open position. The door holding device 100 includes a base support member 10. The base support member 10 includes a first section 11, second section 12 and third section 13 that are contiguously formed and shaped to be secured to wall end 99. The base support member 10 is mechanically coupled to the wall end 99 utilizing suitable mechanical fasteners. While the illustrations herein show the base support member 10 configured to be mounted to a wall end 99, it should be understood within the scope of the present invention that the base support member 10 could be configured with as few as a single section so as to mount flat onto a wall surface.

The base support member 10 includes hinge mount support member 15. The hinge mount support member 15 is secured to the first section 11 of the base support member 10 extending outward therefrom being perpendicular therewith. The hinge mount support member 15 is triangular in shape and is operable to provide the structural stability needed for the hinge mount 20. It should be understood within the scope of the present invention that the hinge mount support member 15 could be manufactured in alternate sizes and shapes and still achieve the desired objective stated herein.

The door holding device 100 includes hinge mount 20. Hinge mount 20 is operably coupled to the first end 31 of arm member 30. Hinge mount 20 facilitates the hingeable movement of the arm member 30 as the door holding device 100 is moved from a first position to a second position. The hinge mount 20 includes a first vertical support member 21 and a second vertical support member 22. The first vertical support member 21 and the second vertical support member 22 extend upward being parallel and having a void 23 therebetween. The void 23 accommodates first end 31 of the arm member 30 allowing hinged movement thereof. A pin 35 is journaled through the first vertical support member 21 and second vertical support member 22 further being journaled through the first end 31 of the arm member 30. Pin 35 facilitates the movable coupling of the arm member 30 to the hinge mount 20. It is contemplated within the scope of the present invention that the arm member 30 could be movably coupled to the hinge mount 20 utilizing alternate mechanical elements in place of and/or in conjunction with the pin 35.

An arm support member 40 is secured to the first section 11 of the base support member 10 distal to the hinge mount support member 15. The arm support member 40 includes a lower section 41, middle section 42 and upper section 43. The lower section 41 is secured to the first section 11 of the base support member 10. The middle section 42 is contiguously formed with the lower section 41 and extends outward being generally perpendicular to the first section 11. The upper section 43 extends upward from the middle section 42 being contiguous therewith and generally perpendicular thereto. The arm support member 40 functions to retain the arm member 30 in a generally horizontal position when the door holding device 100 is not operably engaged with a door. It should be understood within the scope of the present invention that the arm support member 40 could be constructed in alternate manners and achieve the desired objective discussed herein.

Secured to the second end 32 of the arm member 30 is the door engagement member 50. The door engagement member 50 is configured to operably couple with a top edge of a door and maintain engagement therewith until released. The door engagement member 50 is manufactured from flat metal bar or other suitable rigid material. The door engagement member 50 includes forward portion 51 that is oriented in an angular manner so as to engage a top of a door. The forward portion 51 is angular so as upon a door edge pushing thereagainst, the arm member 30 will hinge upwards and the top edge of the door will traverse along the forward portion 51 lifting the door engagement member 50. Once the door reaches the rearward portion 52, the arm member 30 will hinge downwards and place the door engagement member 50 in a position so as to maintain engagement with the door and as such retain the door in an open position. The rearward portion 52 of the door engagement member 50 is substantially vertical in orientation. An upper portion 53 of the door engagement member 50 is operably coupled to the arm member 30 proximate the second end 32 thereof. A lower portion 54 is secured to the arm member 30 opposite the upper portion 53 wherein securing of the upper portion 53 and lower portion 54 is achieved utilizing suitable mechanical fasteners. While a preferred embodiment of the door engagement member 50 is illustrated herein, it is contemplated within the scope of the present invention that the door engagement member 50 could be constructed in alternate manners and achieve the desired objective discussed herein.

The door holding device 100 further includes an outer support arm 60. The outer support arm 60 is mechanically coupled to the upper portion 53 utilizing suitable techniques. The outer support arm 60 is planar in manner being manufactured from metal flat bar and is of a length so as to extend beyond the door engagement member 50. Secured to the outer support arm 60 is keeper 65 wherein the keeper 65 functions to be operably coupled to a release member 70. Release member 70 provides the user of the door holding device 100 a technique to lift the door engagement member 50 in an upwards direction so as to disengage the door engagement member 50 to facilitate closing of the door. The release member 70 is secured at points 72 so as to direct a portion of the release member 70 to a location so as to be grasped by a user. It should be understood that keeper 65 could be manufactured from various types of mechanical fasteners and that points 72 could vary based on the desired directional placement of the release member 70. While various materials could be employed to manufacture the release member 70, a preferred embodiment of the release member is nylon line or string.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A door holding device that is configured to operably couple with a door and maintain in an open position wherein the door holding device is movable between a first position and a second position and wherein the door holding device comprises:
a base support member, said base support member being configured to be secured to a surface of a wall proximate a door;
a hinge mount, said hinge mount being secured to said base support member, said hinge mount having a first vertical support member and a second vertical support member, said first vertical support member and said second vertical support member having a void therebetween, said first vertical support member and said second vertical support member extending upward from said base support member;
an arm member, said arm member having a first end and a second end, said first end of said arm member being hingedly secured with said hinge mount, said first end of said arm member being hingedly mounted with a pin between said first vertical support member and said second vertical support member of said hinge mount, said arm member configured to hingedly move in an upwards-downwards direction;
a door engagement member, said door engagement member being operably coupled to said second end of said arm member, said door engagement member extending outward from said second end of said door member, said door engagement member having a forward portion, said forward portion being angularly oriented so as to engage a top edge of a door and traverse upwards with respect thereto, said door engagement member having a rearward portion, said rearward portion being vertical in orientation and contiguously formed with said forward portion, said rearward portion configured to be adjacent a surface of a door so as to releasably secure thereagainst; and
wherein the door holding device is configured to releasably secure a door proximate thereto in an open position until the door holding device 100 is moved to a second position.

2. The door holding device that is configured to operably couple with a door and maintain in an open position as recited in claim 1, wherein in said second position the door holding device is lifted at an angle so as to place the door engagement member above an upper edge of a door.

3. The door holding device that is configured to operably couple with a door and maintain in an open position as recited in claim 2, wherein in said first position the arm member of the door holding device is in a horizontal position.

4. The door holding device that is configured to operably couple with a door and maintain in an open position as recited in claim 3, and further including an arm support member, said arm support member being secured to said base support member, said arm support member being distally located on said base support member from said hinge mount, said arm support member operable to engage said arm member and maintain in a horizontal position.

5. The door holding device that is configured to operably couple with a door and maintain in an open position as recited in claim 4, and further including an outer support arm, said outer support arm being superposed said arm member an upper portion of said door engagement member, said outer support arm having a portion extending beyond said door engagement member.

6. The door holding device that is configured to operably couple with a door and maintain in an open position as recited in claim 5, and further including a hinge mount support member, said hinge mount support member being secured to said base support member, said hinge mount support member extending outward from said base support member, said hinge mount support member configured to provide structural support for said hinge mount.

7. The door holding device that is configured to operably couple with a door and maintain in an open position as recited in claim 6, and further including a release member, said release member being secured to said outer support arm, said release member configured to move the door holding device upwards towards said second position.

8. The door holding device that is configured to operably couple with a door and maintain in an open position as recited in claim 7, wherein said release member is secured at points on walls adjacent the door with which the door holding device is configured to operably engage.
